(19) United States
(12) Patent Application Publication
(10) Pub. No.: US 2013/0176245 A1
(43) Pub. Date: Jul. 11, 2013

(54) APPARATUS AND METHOD FOR ZOOMING TOUCH SCREEN IN ELECTRONIC DEVICE

(71) Applicant: Samsung Electronics Co., Ltd, Gyeonggi-do (KR)

(72) Inventor: Woo-Up Kwon, Seoul (KR)

(73) Assignee: SAMSUNG ELECTRONICS CO., LTD, Gyeonggi-do (KR)

(21) Appl. No.: 13/682,690

(22) Filed: Nov. 20, 2012

(30) Foreign Application Priority Data
Jan. 11, 2012 (KR) 10-2012-0003526

(51) Int. Cl. G06F 3/041

(52) U.S. Cl. CPC G06F 3/041
USPC 345/173

(57) ABSTRACT

An apparatus and method zoom into a screen in an electronic device employing a touch screen. The method includes, upon detection of a touch input, confirming a zoom-in area by considering touch information, confirming a zoom-in ratio for the zoom-in area, and displaying the zoom-in area by zooming in the area according to the zoom-in ratio.

### CROSS-REFERENCE TO RELATED APPLICATION(S) AND CLAIM OF PRIORITY

The present application is related to and claims the benefit under 35 U.S.C.§119(a) of a Korean patent application filed in the Korean Intellectual Property Office on Jan. 11, 2012 and assigned Serial No. 10-2012-0003526, the entire disclosure of which is hereby incorporated by reference.

### TECHNICAL FIELD OF THE INVENTION

The present disclosure relates to an apparatus and method for zooming in a screen in an electronic device employing a touch screen.

### BACKGROUND OF THE INVENTION

Functions of electronic devices are more advanced with the development of general technologies such as wired or wireless communication technologies, multimedia technologies, hardware manufacturing technologies such as a Central Processing Unit (CPU) and a memory, power charging technologies, etc.

Recently, as multimedia service is provided, there is an increase in an information amount to be processed and displayed. As a result, there is a growing interest in an electronic device employing a touch screen capable of increasing a size of a display portion by improving space utilization.

The touch screen is an input and display device which inputs and displays information in one screen. Accordingly, when the electronic device uses the touch screen, the electronic device can increase a display area by removing an additional input device such as a key pad. For example, in case of using a full touch scheme in which the touch screen is applied to a full screen, a screen display area can be widely used by utilizing a front surface of the electronic device as the screen.

Since the electronic device employing the touch screen does not use an additional input device such as the key pad, a method of manipulating the electronic device must be changed. Accordingly, there is a need for a user interface for the electronic device employing the touch screen.

### SUMMARY OF THE INVENTION

To address the above-discussed deficiencies of the prior art, it is a primary object to provide an apparatus and method for zooming in a screen in an electronic device employing a touch screen.

Another aspect of the present disclosure is to provide an apparatus and method for zooming in a screen by considering touch information in an electronic device employing a touch screen.

Another aspect of the present disclosure is to provide an apparatus and method for zooming in a screen by considering multi-touch information in an electronic device employing a touch screen.

Another aspect of the present disclosure is to provide an apparatus and method for zooming in a screen of an area desired by a user in an electronic device employing a touch screen.

Another aspect of the present disclosure is to provide an apparatus and method for confirming a screen zoom-in area by considering touch information in an electronic device employing a touch screen.

In accordance with an aspect of the present disclosure, a method of zooming in a screen in an electronic device employing a touch screen is provided. The method includes, upon detection of a touch input, confirming a zoom-in area by considering touch information, confirming a zoom-in ratio for the zoom-in area, and displaying the zoom-in area by zooming in the area according to the zoom-in ratio.

In accordance with another aspect of the present disclosure, an apparatus for zooming in a screen in an electronic device is provided. The apparatus includes a touch screen, and a controller for, upon detection of a touch input through the touch screen, displaying a zoom-in area, confirmed by considering touch information, by zooming in the area according to a zoom-in ratio.

In accordance with another aspect of the present disclosure, an apparatus for zooming in a screen in an electronic device is provided. The apparatus includes one or more controllers, a storage unit, and one or more programs stored in the storage unit and configured to be executable by the one or more controllers, wherein the program includes a command for, upon detection of a touch input, confirming a zoom-in area by considering the touch information and for confirming a zoom-in ratio for the zoom-in area, and a command for displaying the zoom-in area by zooming in the area according to the zoom-in ratio.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to an exemplary embodiment of the present disclosure;

FIG. 2 illustrates a flowchart of a process of zooming in a screen by considering multi-touch information in an electronic device according to an exemplary embodiment of the present disclosure;

FIGS. 3A and 3B illustrate a screen configuration for zooming in a screen by considering multi-touch information in an electronic device according to an exemplary embodiment of the present disclosure;

FIG. 4 illustrates a flowchart of a process of zooming in a screen by considering a touch duration time in an electronic device according to an exemplary embodiment of the present disclosure;

FIGS. 5A, 5B and 5C illustrate a screen configuration for zooming in a screen by considering a touch duration time in an electronic device according to an exemplary embodiment of the present disclosure;

FIG. 6 illustrates a flowchart of a process of zooming in a screen by using a screen zoom-in icon in an electronic device according to an exemplary embodiment of the present disclosure; and

FIGS. 7A, 7B, 7C and 7D illustrate a screen configuration for zooming in a screen by using a screen zoom-in icon in an electronic device according to an exemplary embodiment of the present disclosure.

### DETAILED DESCRIPTION OF THE INVENTION

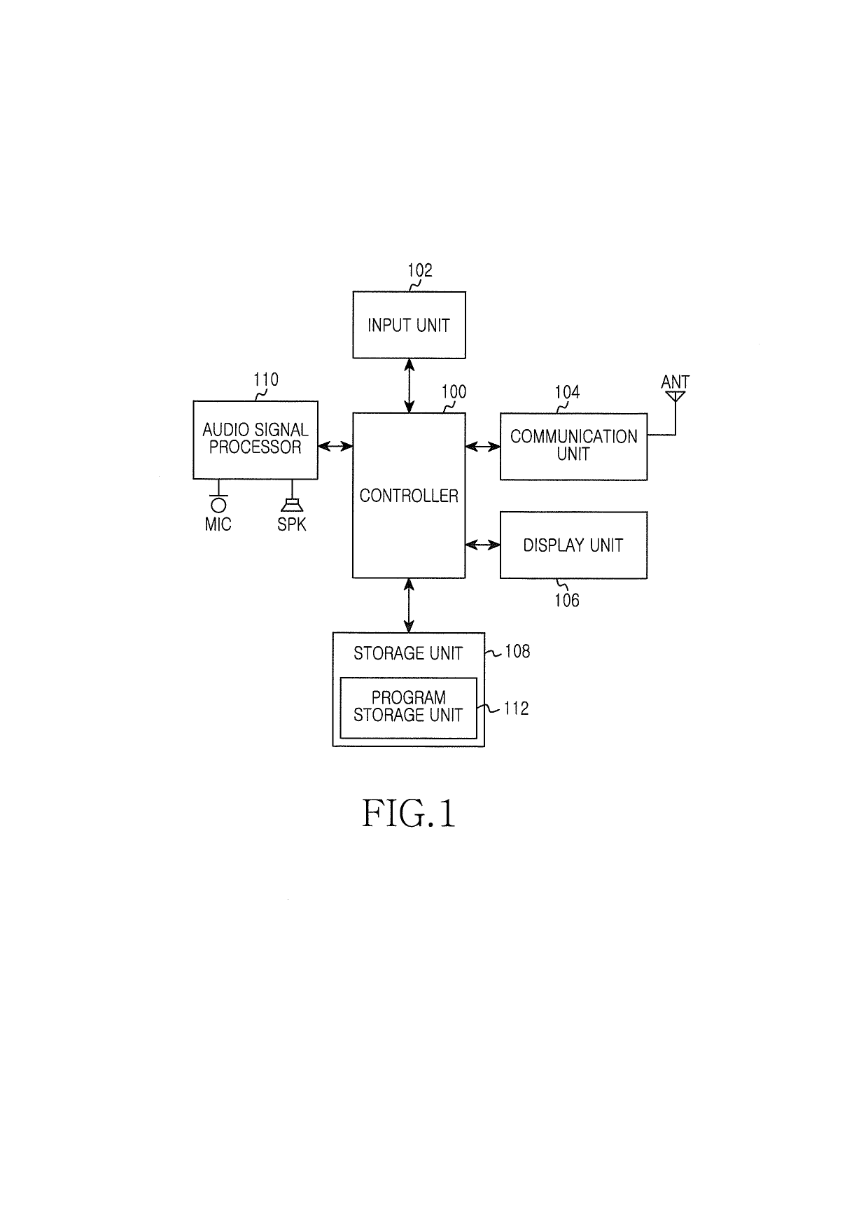

FIGS. 1 through 7D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on a user's or operator's intension and usage. That is, the terms used herein must be understood based on the descriptions made herein.

Hereinafter, a technique for zooming in a screen in an electronic device employing a touch screen will be described.

The electronic device described hereinafter includes a mobile communication terminal employing a touch screen, a smart phone, a Personal Digital Assistant (PDA), a Mobile Internet Device (MID), a laptop, an Ultra Mobile Personal Computer (UMPC), a tablet Personal Computer (PC), a net-book, a navigation, an MPEG-1 Audio Layer 3 (MP3) player, a Portable Multimedia Player (PMP), etc.

FIG. 1 illustrates a block diagram of an electronic device according to an exemplary embodiment of the present disclosure.

As illustrated, the electronic device includes a controller 100, an input unit 102, a communication unit 104, a display unit 106, a storage unit 108, and an audio signal processor 110.

The controller 100 provides overall control to the electronic device.

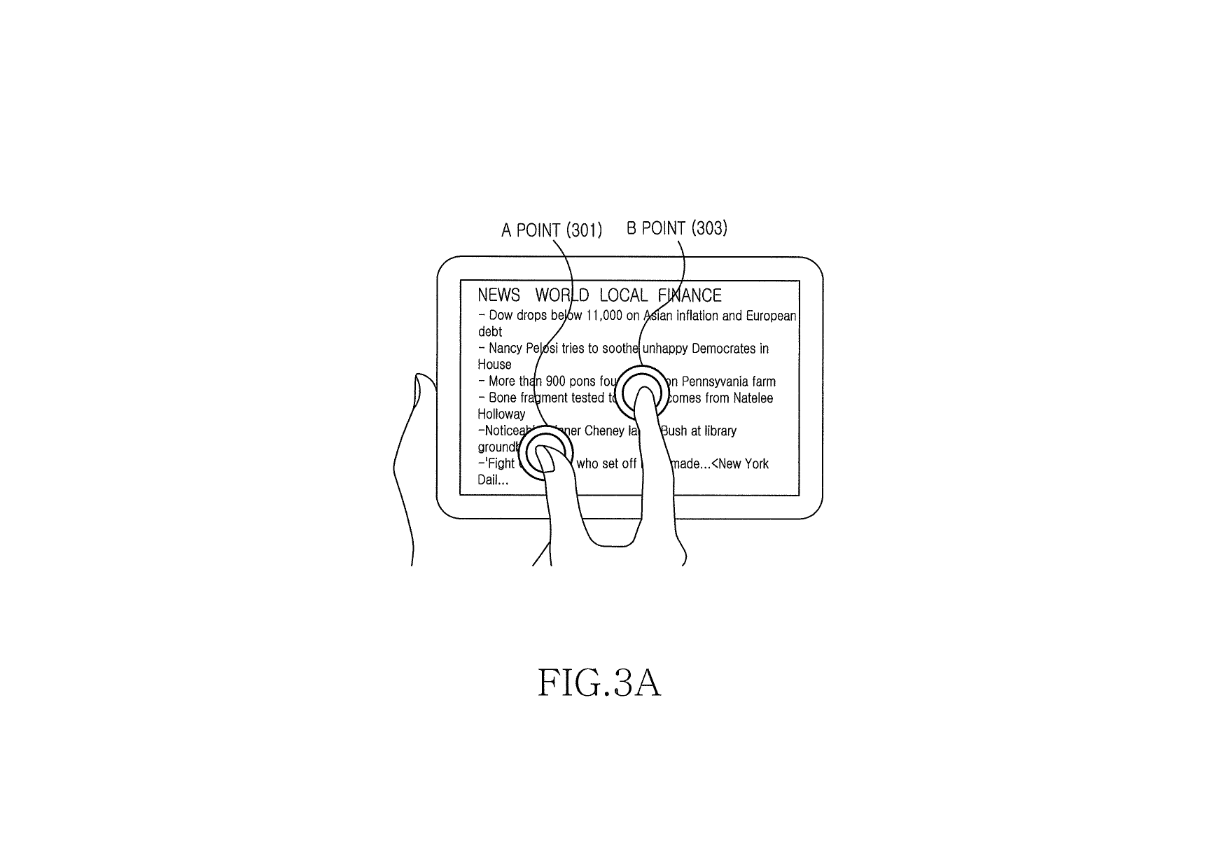

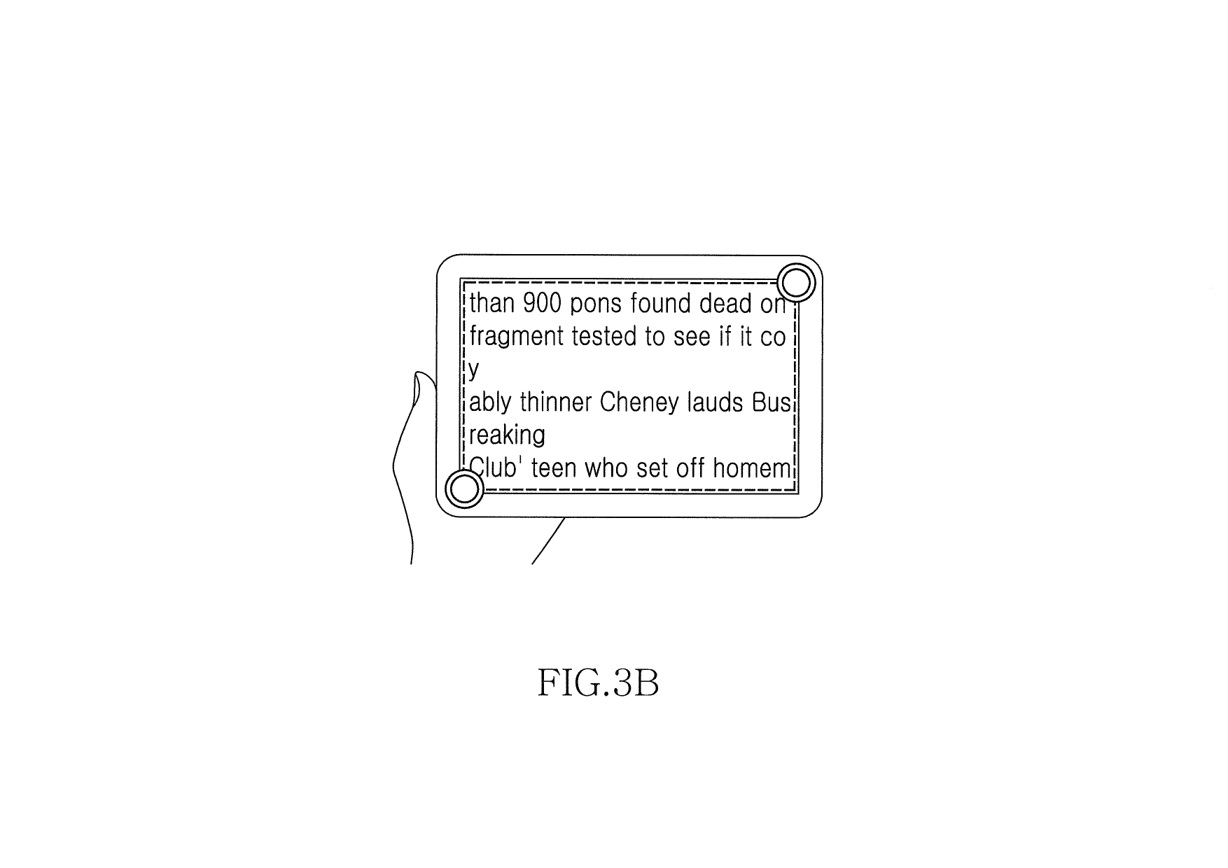

The controller 100 provides control to zoom in a screen by considering touch information of a user. For example, at the occurrence of a multi-touch event as illustrated in FIG. 3A, the controller 100 confirms a screen zoom-in area by considering the multi-touch information. Thereafter, as illustrated in FIG. 3B, the controller 100 provides control to zoom in the screen zoom-in area. In this example, the controller 100 zooms in the screen zoom-in area according to a pre-set screen zoom-in ratio or a screen zoom-in ratio determined by the user.

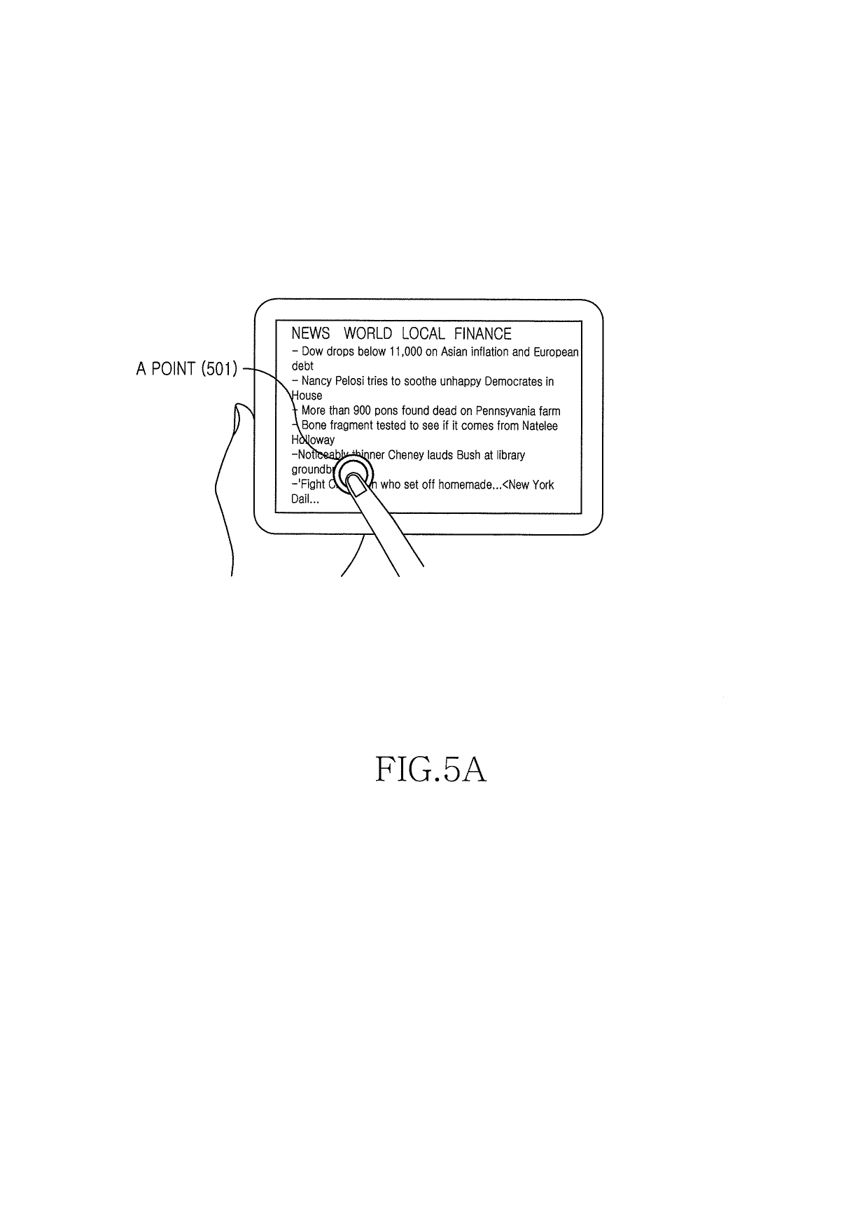

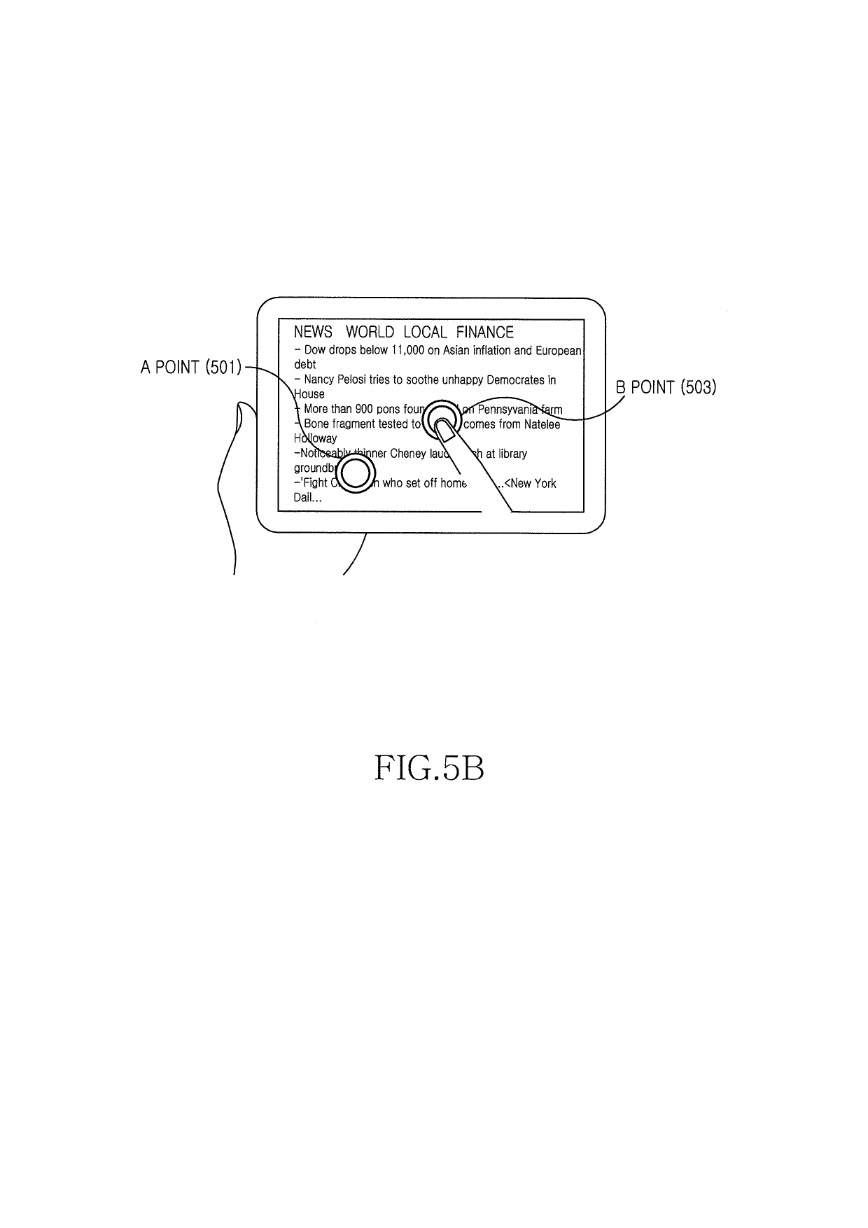

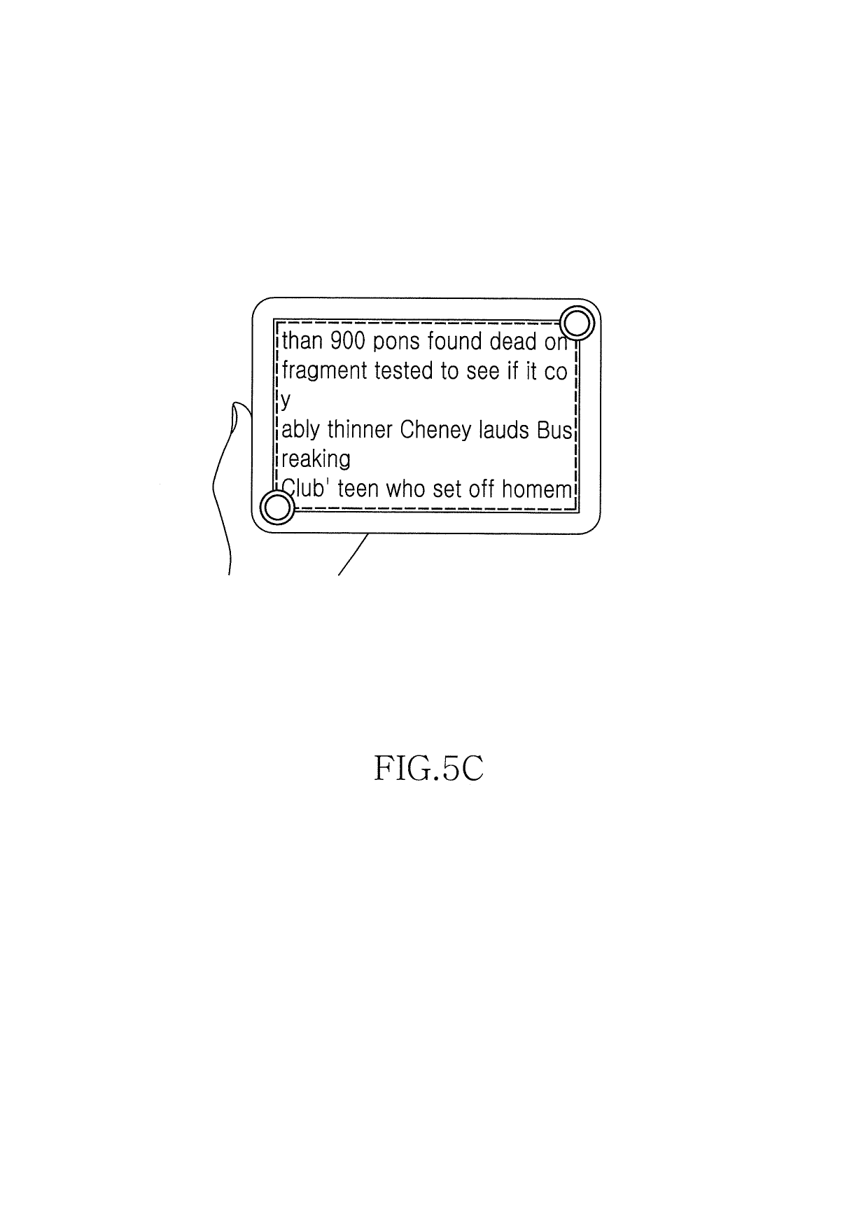

For another example, if a first touch (see a reference numeral 501 of FIG. 5) of the user is maintained for more than a reference time as illustrated in FIG. 5A, the controller 100 activates a screen zoom-in mode. Thereafter, upon detection of a second touch input, the controller 100 confirms the screen zoom-in area by considering an A-point 501 based on the first touch and a B-point 503 based on the second touch as illustrated in FIG. 5B. Thereafter, the controller 100 provides control to zoom in the screen zoom-in area as illustrated in FIG. 5C. In this example, the controller 100 zooms in the screen zoom-in area according to the pre-set screen zoom-in ratio or the screen zoom-in ratio determined by the user.

For another example, if the first touch 501 of the user is maintained for more than the reference time as illustrated in FIG. 5A, the controller 100 activates the screen zoom-in mode. Thereafter, upon detection of a drag of the first touch, the controller 100 confirms the screen zoom-in area by considering a drag distance of the first touch. Thereafter, the controller 100 provides control to zoom in the screen zoom-in area as illustrated in FIG. 5C. In this example, the controller 100 zooms in the screen zoom-in area according to the pre-set screen zoom-in ratio or the screen zoom-in ratio determined by the user.

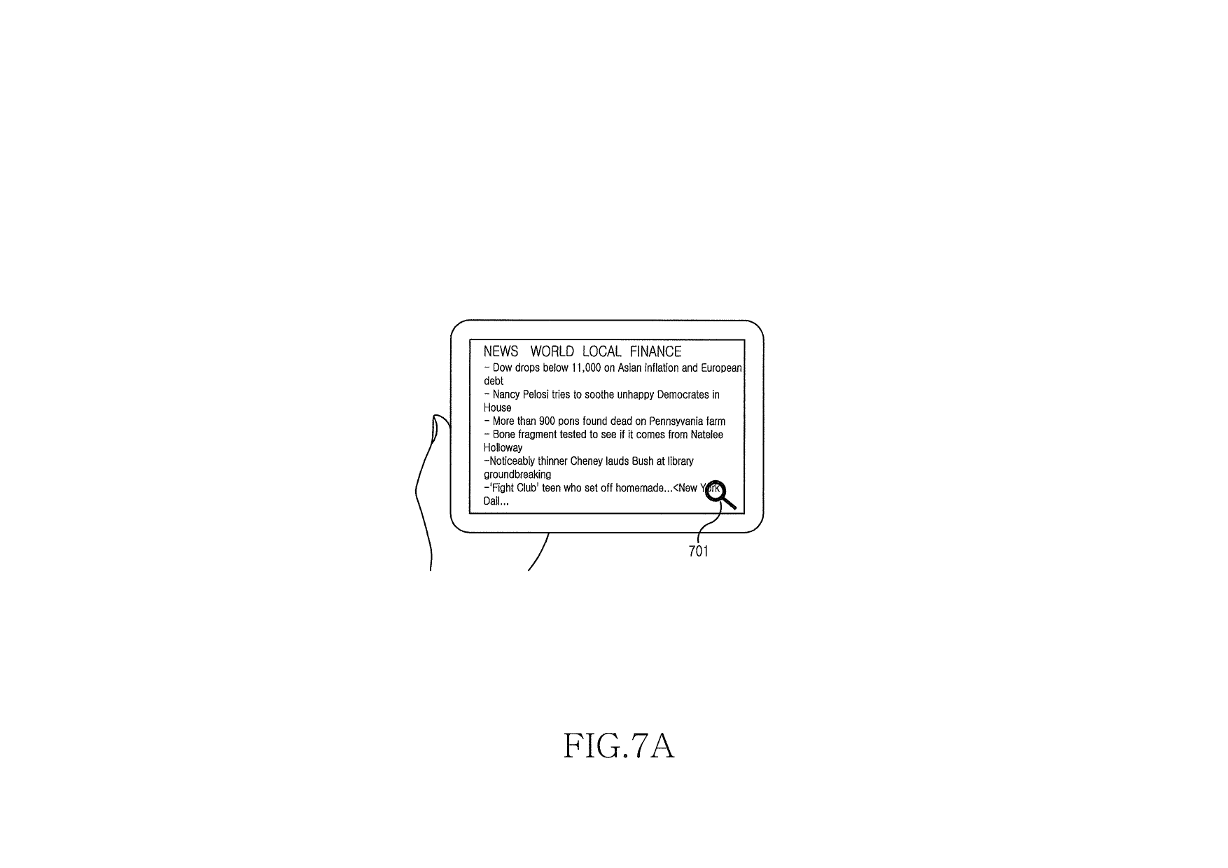

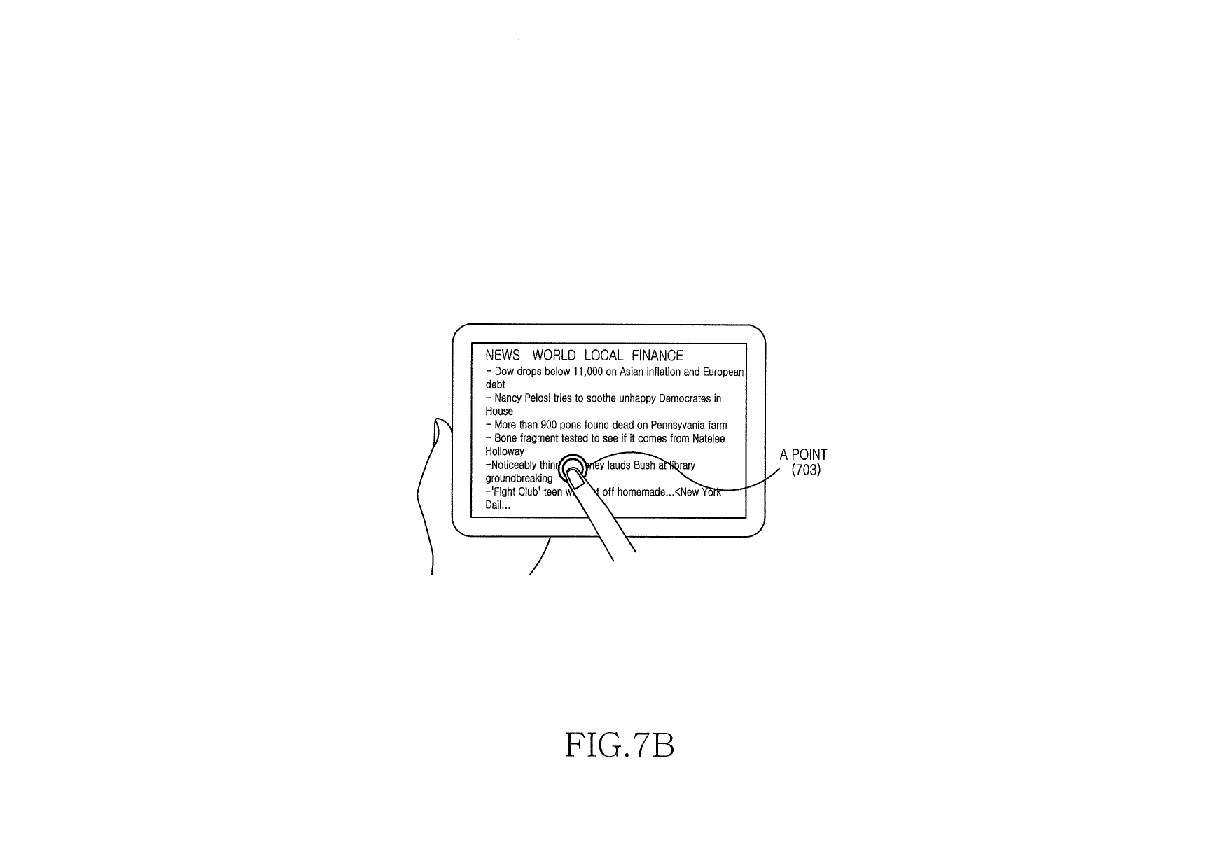

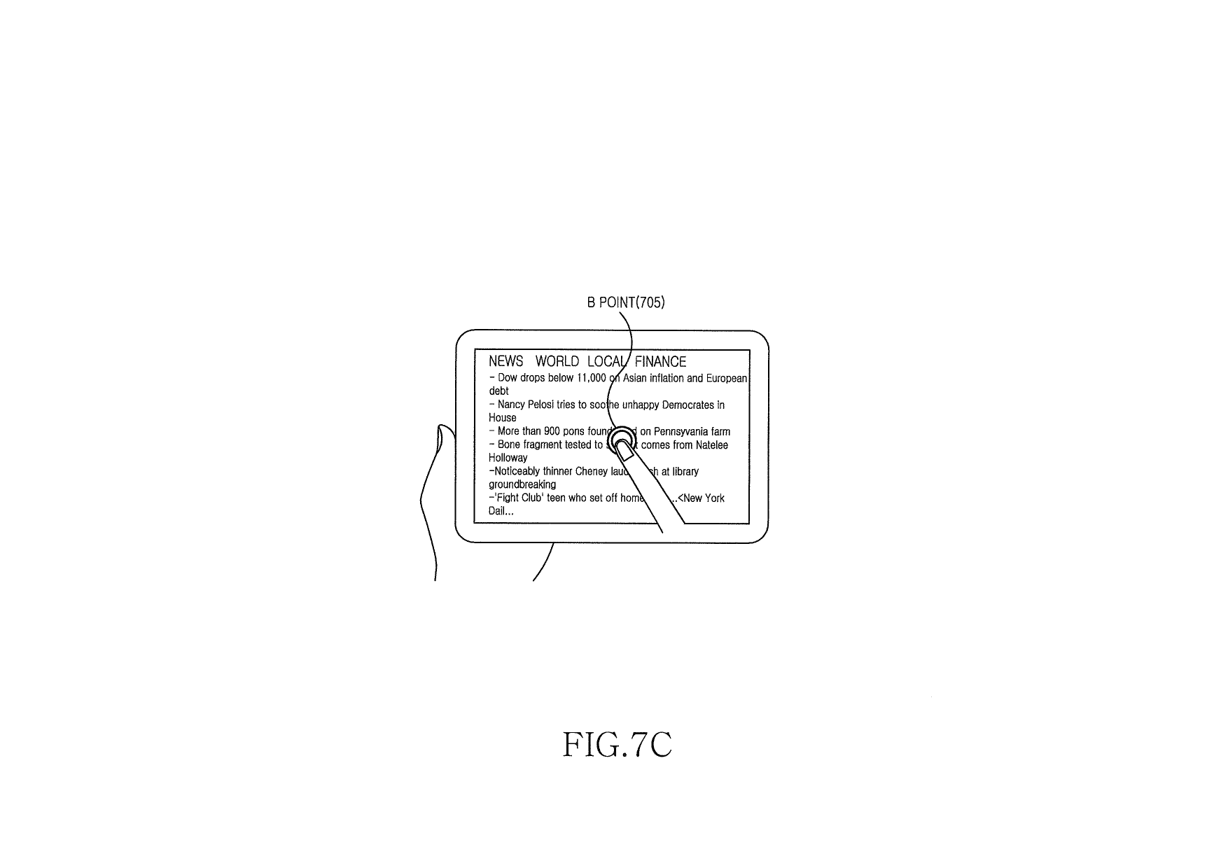

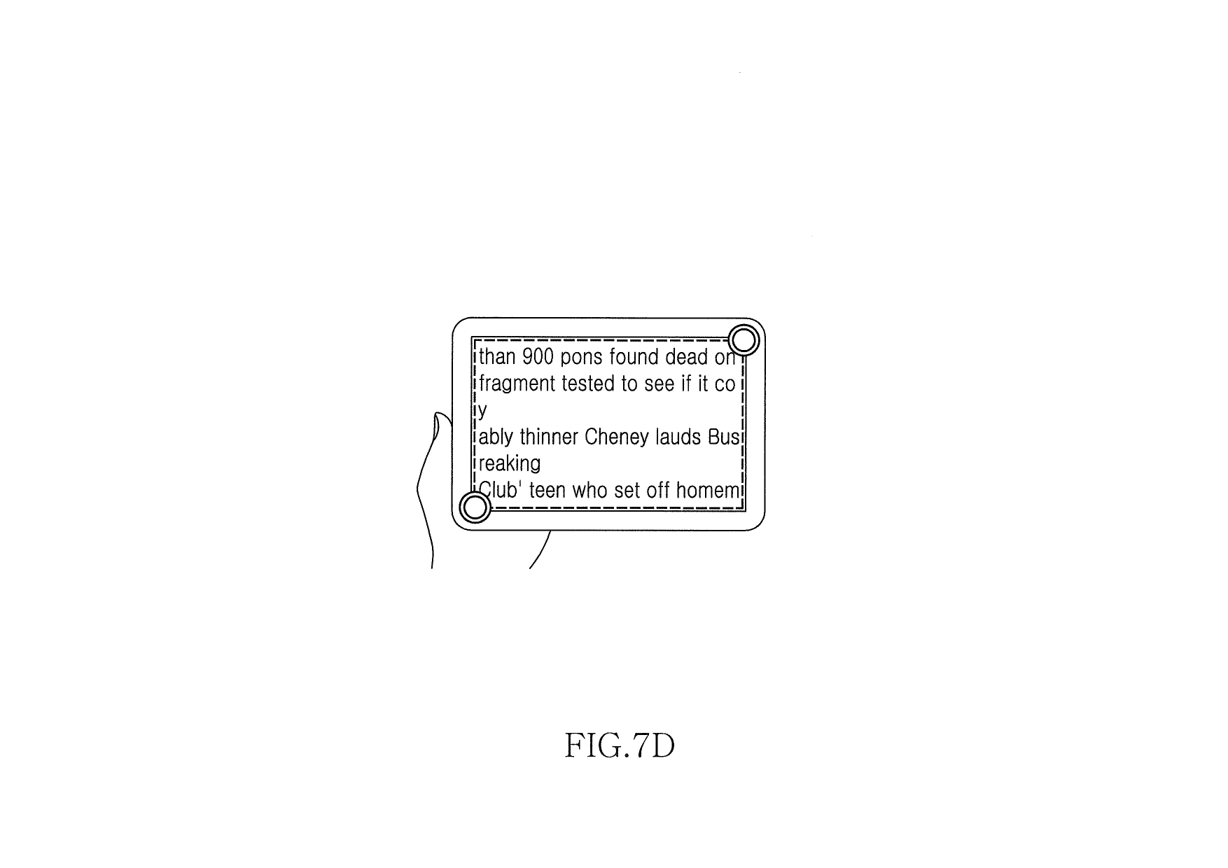

For another example, if a screen zoom-in icon is selected as illustrated in FIG. 7A, the controller 100 activates the screen zoom-in mode. Thereafter, the controller 100 zooms in the screen zoom-in area determined by considering a plurality of touch points as illustrated in FIGS. 7B and 7C. Thereafter, the controller 100 provides control to zoom in the screen zoom-in area as illustrated in FIG. 7D. In this example, the controller 100 zooms in the screen zoom-in area according to the pre-set screen zoom-in ratio or the screen zoom-in ratio determined by the user.

The input unit 102 provides the controller 100 with input data generated by a user's selection. For one example, the input unit 102 includes a button for controlling the electronic device. For another example, the input unit 102 may include a key pad to receive input data from the user in addition to the display unit 106.

For voice and data communication, the communication unit 104 processes a signal transmitted and received through an antenna.

The display unit 106 performs a function of displaying information. Accordingly, the display unit 106 displays status information of the electronic device, a character which is input by the user, a motion image, a still image, or the like under the control of the controller 100. For one example, the display unit 106 displays the screen zoom-in area by zooming in the area under the control of the controller 100. For another example, the display unit 106 displays the screen zoom-in icon as illustrated in FIG. 7A.

If the display unit 106 consists of a touch screen, the display unit 106 provides the controller 100 with input data provided by using the touch screen.

The storage unit 108 may include a program storage unit 112 to store a program for controlling an operation of the electronic device and a data storage unit to store data generated while the program is executed. For one example, the data storage unit stores the screen zoom-in ratio. For another example, the program storage unit 112 can store a program or a command set as a group of commands for zooming in the screen in the controller 100.

The audio signal processor 110 controls an input/output of an audio signal. For example, the audio signal processor 110 outputs an audio signal provided from the controller 100 to an external element through a speaker, and provides an audio signal provided from a microphone to the controller 100.

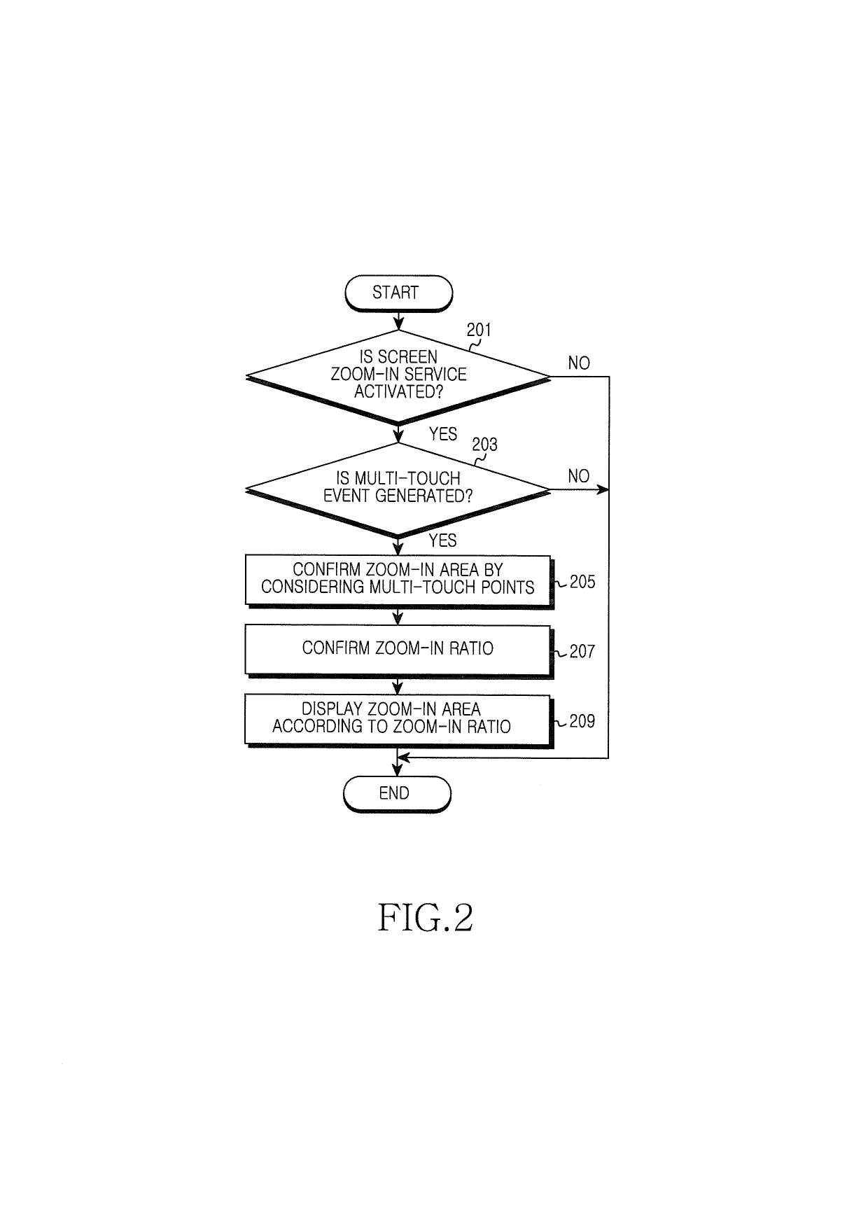

FIG. 2 illustrates a flowchart of a process of zooming in a screen by considering multi-touch information in an electronic device according to an exemplary embodiment of the present disclosure.

Referring to FIG. 2, the controller 100 confirms whether a screen zoom-in service is activated in step 201. For example, the controller 100 confirms whether a screen zoom-in menu is configured by a user.

If the screen zoom-in service is not activated, the controller 100 ends the procedure of FIG. 2.

Otherwise, if the screen zoom-in service is activated, proceeding to step 203, the controller 100 confirms whether a multi-touch event occurs. For example, the controller 100 confirms whether the display unit 106 is multiple-touched by the user as illustrated in FIG. 3A.

If the multi-touch event does not occur, the procedure of FIG. 2 ends.

Otherwise, if the multi-touch event occurs, proceeding to step 205, the controller 100 confirms a screen zoom-in area by considering multi-touch information. For example, the controller 100 confirms the screen zoom-in area by considering an A-point 301 and B-point 303 touched by the user as illustrated in FIG. 3A.

In addition, if the multi-touch event occurs, proceeding to step 207, the controller 100 confirms a screen zoom-in ratio. For one example, the controller 100 can determine the screen zoom-in ratio by considering a size of the display unit 106 and a size of the screen zoom-in area confirmed in step 205. For another example, the controller 100 may confirm a screen zoom-in ratio determined by the user. For another example, the controller 100 may confirm a pre-set screen zoom-in ratio.

In step 209, the controller 100 zooms in a screen by considering the screen zoom-in area confirmed in step 205 and the screen zoom-in ratio confirmed in step 207. For example, the controller 100 confirms the screen zoom-in area as illustrated in FIG. 3A, and thereafter zooms in the screen as illustrated in FIG. 3B by considering the screen zoom-in ratio.

Thereafter, the procedure of FIG. 2 ends.

In the aforementioned embodiment, the controller 100 confirms the screen zoom-in area by considering multi-touch information in step 205, and thereafter confirms the screen zoom-in ratio in step 207. In this example, the controller 100 can perform a process of confirming the screen zoom-in area and a process of confirming the screen zoom-in ratio in a parallel manner. Accordingly, the controller 100 can confirm the screen zoom-in ratio in step 207, and thereafter can confirm the screen zoom-in area by considering the multi-touch information in step 205.

In the aforementioned embodiment, the controller 100 provides the screen zoom-in service by considering the multi-touch information.

In another embodiment, the controller 100 can provide the screen zoom-in service by considering a touch duration time.

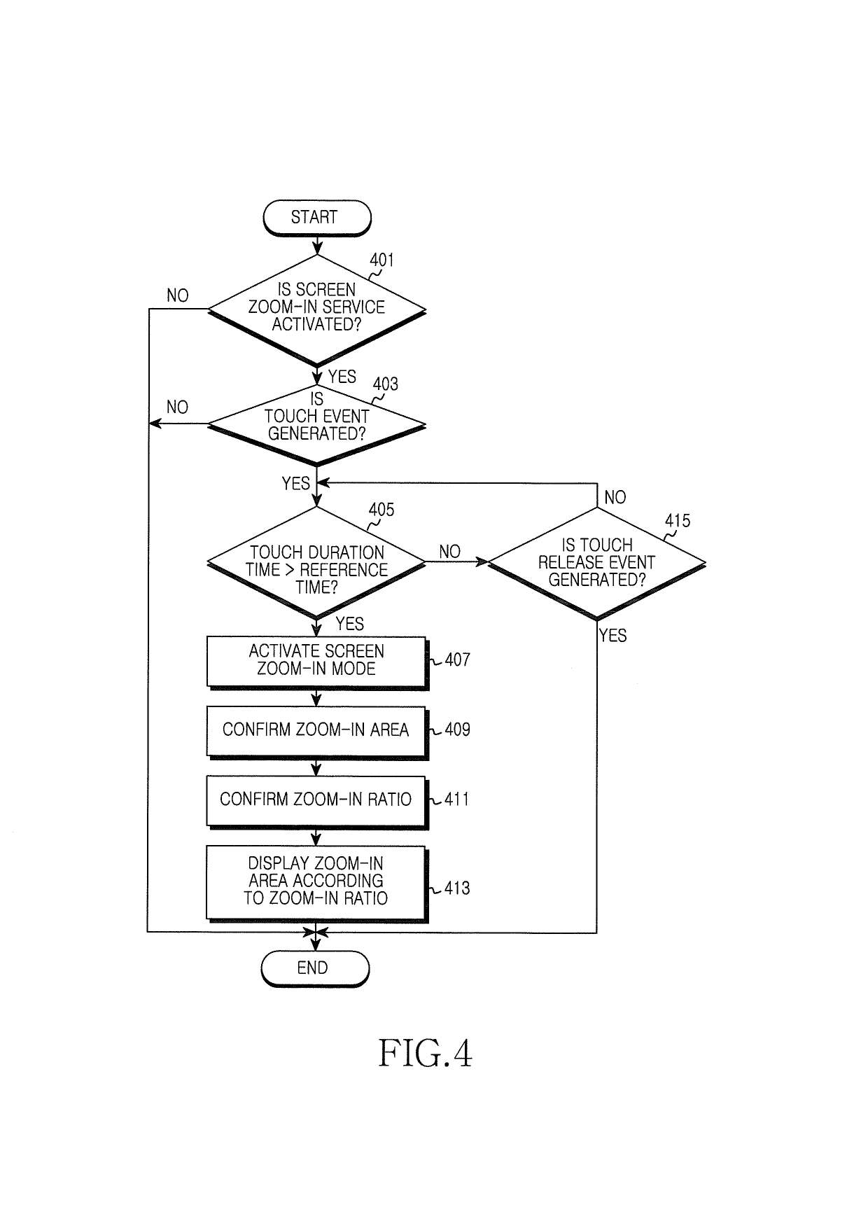

FIG. 4 illustrates a flowchart of a process of zooming in a screen by considering a touch duration time in an electronic device according to an exemplary embodiment of the present disclosure.

Referring to FIG. 4, the controller 100 confirms whether a screen zoom-in service is activated in step 401. For example, the controller 100 confirms whether a screen zoom-in menu is configured by a user.

If the screen zoom-in service is not activated, the procedure of FIG. 4 ends.

Otherwise, if the screen zoom-in service is activated, proceeding to step 403, the controller 100 confirms whether a touch event occurs. For example, the controller 100 confirms whether the display unit 106 is touched by the user as illustrated in FIG. 5A.

If the touch event does not occur, the procedure of FIG. 4 ends.

Otherwise, if the touch event occurs, proceeding to step 405, the controller 100 compares a touch duration time and a reference time to determine whether a screen zoom-in mode is activated. That is, the controller 100 confirms whether the touch duration time is mater than the reference time. For example, if the A-point 501 is touched by the user as illustrated in FIG. 5A, the controller 100 compares the touch duration time and the reference time.

If the touch duration time is greater than the reference time, proceeding to step 407, the controller 100 activates the screen zoom-in mode.

After activating the screen zoom-in mode, proceeding to step 409, the controller 100 confirms a screen zoom-in area. For one example, if a touch is detected in the B-point 503 as illustrated in FIG. 5B, the controller 100 confirms the screen zoom-in area by considering the A-point 501 and B-point 503 touched by the user. For another example, if a touch drag is detected in the A-point 501, the controller 100 may confirm the screen zoom-in area by considering a touch drag distance of the A-point 501.

Further, after activating the screen zoom-in mode, proceeding to step 411, the controller 100 confirms a screen zoom-in ratio. For one example, the controller 100 may determine the screen zoom-in ratio by considering a size of the display unit 106 and a size of the screen zoom-in area confirmed in step 409. For another example, the controller 100 may confirm a screen zoom-in ratio determined by the user. For another example, the controller 100 may confirm a pre-set screen zoom-in ratio.

Thereafter, proceeding to step 413, the controller 100 zooms in the screen by considering the screen zoom-in area confirmed in step 409 and the screen zoom-in ratio confirmed in step 411. For example, the controller 100 confirms the screen zoom-in area as illustrated in FIG. 5B, and zooms in the screen as illustrated in FIG. 5C by considering the screen zoom-in ratio.

Meanwhile, if the touch duration time is less than the reference time, proceeding to step 415, the controller 100 confirms whether a touch release event occurs.

If the touch release event does not occur, returning to step 405, the controller 100 compares the touch duration time and the reference time.

Otherwise, if the touch release event occurs, the controller 100 recognizes that the screen zoom-in mode is not activated. Accordingly, the procedure of FIG. 4 ends.

Thereafter, the procedure of FIG. 4 ends.

In the aforementioned exemplary embodiment, the controller 100 confirms the screen zoom-in area by considering touch information in step 409, and confirms the screen zoom-in ratio in step 411. In this example, the controller 100 can perform a process of confirming the screen zoom-in area and a process of confirming the screen zoom-in ratio in a parallel manner. Accordingly, the controller 100 can confirm the screen zoom-in ratio in step 411, and thereafter can confirm the screen zoom-in area by considering the touch information in step 409.

If a screen zoom-in service is activated in the aforementioned exemplary embodiment of the present disclosure, the screen zoom-in service is provided.

In another exemplary embodiment, an icon can be used to activate the screen zoom-in service in the electronic device.

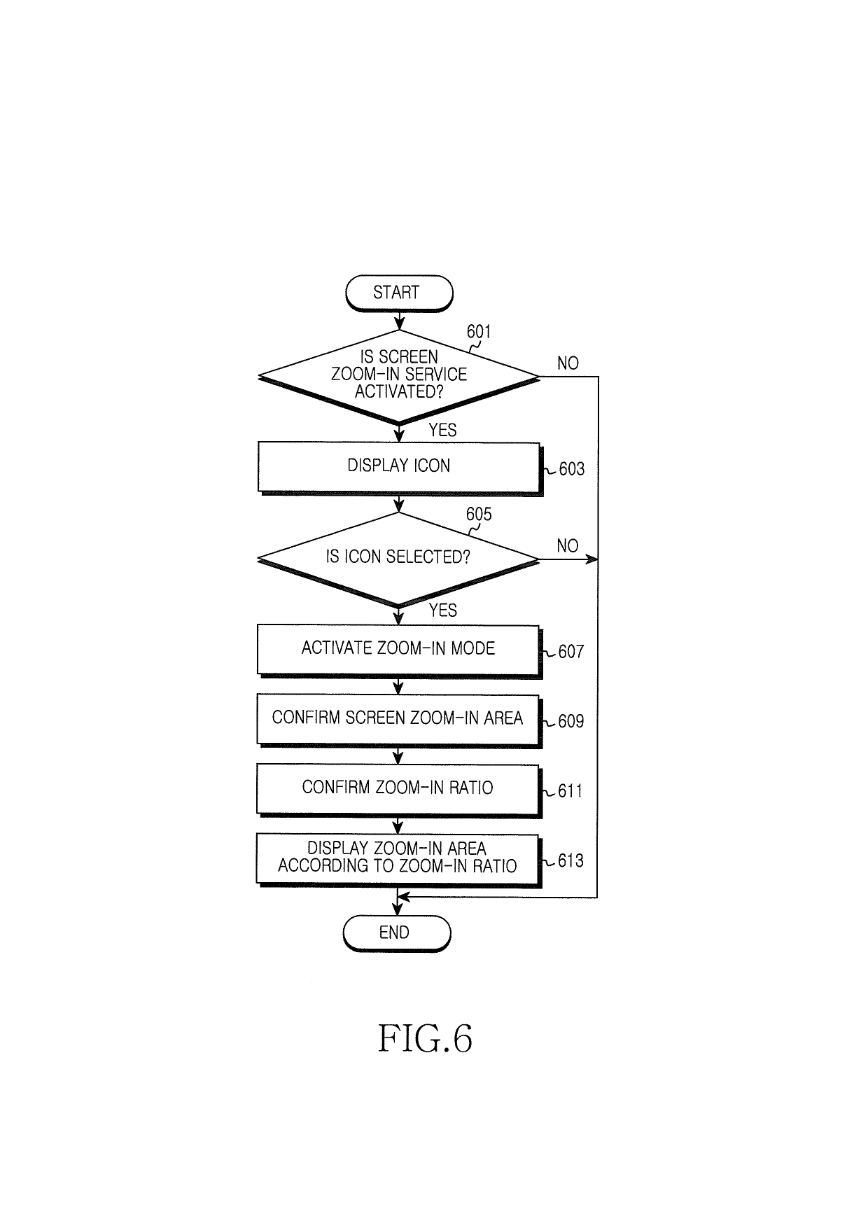

FIG. 6 illustrates a flowchart of a process of zooming in a screen by using a screen zoom-in icon in an electronic device according to an exemplary embodiment of the present disclosure.

Referring to FIG. 6, the controller 100 confirms whether a screen zoom-in service is activated in step 601. For example, the controller 100 confirms whether a screen zoom-in menu is configured by a user.

If the screen zoom-in service is not activated, the procedure of FIG. 6 ends.

Otherwise, if the screen zoom-in service is activated, proceeding to step 603, the controller 100 displays a screen zoom-in icon. For example, the controller 100 displays a screen zoom-in icon 701 to the display unit 106 as illustrated in FIG. 7A. Herein, a position of the screen zoom-in icon can be changed by the user.

In step 605, the controller 100 confirms whether the screen zoom-in icon is selected. For example, the controller 100 confirms whether the screen zoom-in icon displayed in step 603 is touched by the user.

If the screen zoom-in icon is not selected, the procedure of FIG. 6 ends.

Otherwise, if the screen zoom-in icon is selected, proceeding to step 607, the controller 100 activates a screen zoom-in mode.

After activating the screen zoom-in mode, proceeding to step 609, the controller 100 confirms the screen zoom-in area. For one example, the controller 100 confirms the screen zoom-in area by considering an A-point 703 and B-point 705 touched by the user as illustrated in FIGS. 7B and C. For another example, after activating the screen zoom-in mode, the screen zoom-in area can be confirmed by considering multi-touch information touched by the user.

In addition, after activating the screen zoom-in mode, proceeding to step 611, the controller 100 confirms the screen zoom-in ratio. For one example, the controller 100 can determine the screen zoom-in ratio by considering a size of the display unit 106 and a size of the screen zoom-in area confirmed in step 609. For another example, the controller 100 may confirm a screen zoom-in ratio determined by the user. For another example, the controller 100 may confirm a pre-set screen zoom-in ratio.

In step 613, the controller 100 zooms in a screen by considering the screen zoom-in area confirmed in step 609 and the screen zoom-in ratio confirmed in step 611. For example, the controller 100 confirms the screen zoom-in area as illustrated in FIGS. 7B and C, and thereafter zooms in the screen as illustrated in FIG. 7D by considering the screen zoom-in ratio.

Thereafter, the procedure of FIG. 6 ends.

In the aforementioned embodiment, the controller 100 confirms the screen zoom-in area by considering multi-touch information in step 609, and thereafter confirms the screen zoom-in ratio in step 611. In this example, the controller 100 can perform a process of confirming the screen zoom-in area and a process of confirming the screen zoom-in ratio in a parallel manner. Accordingly, the controller 100 can confirm the screen zoom-in ratio in step 611, and thereafter can confirm the screen zoom-in area by considering the multi-touch information in step 609.

As described above, since a screen zoom-in service for an area desired by a user is provided by considering touch information in an electronic device employing a touch screen, there is an advantage in that the user of the electronic device can easily use the screen zoom-in service.

The above-described methods as described in the claims and/or the specification of the present disclosure can be implemented in hardware or software alone or in combination.

As for the software, a computer-readable storage medium containing one or more programs (software modules) can be provided. One or more programs stored to the computer-readable storage medium are configured for execution of one or more processors of an electronic device such as portable terminal. One or more programs include instructions making the electronic device execute the methods according to the exemplary embodiments as described in the claims and/or the specification of the present disclosure.

Such programs (software module, software) can be stored to a random access memory, a non-volatile memory including a flash memory, a ROM, an Electrically Erasable Programmable ROM (EEPROM), a magnetic disc storage device, a compact disc ROM, Digital Versatile Discs (DVDs) or other optical storage devices, and a magnetic cassette. Alternatively, the programs can be stored to a memory combining part or all of those recording media. A plurality of memories may be equipped.

The programs can be stored to an attachable storage device of the electronic device accessible via the communication network such as Internet, Intranet, LAN, Wireless LAN (WLAN), or Storage Area Network (SAN), or a communication network alone or in combination. The storage device can access the electronic device through an external port.

A separate storage device in the communication network can access the portable electronic device.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of zooming in a screen in an electronic device employing a touch screen, the method comprising:
in response to detecting a touch input, determining, a zoom-in area based on touch information;
determining a zoom-in ratio for the zoom-in area; and
displaying the zoom-in area by zooming into the zoom-in area according to the zoom-in ratio.

2. The method of claim 1, wherein determining the zoom-in area comprises, in response to detecting a multi-touch input, determining the zoom-in area based on multiple touch points associated with the multi-touch input.

3. The method of claim 1, wherein determining the zoom-in area comprises:
in response to detecting a first touch input, activating a screen zoom-in mode based on a touch duration time of the first touch input; and
in response to detecting a second touch input, determining the zoom-in area based on multiple touch points associated with the first touch input and the second touch input.

4. The method of claim 1, wherein determining the zoom-in area comprises:
in response to detecting a first touch input, activating a screen zoom-in mode based on a touch duration time of the first touch input; and
in response to detecting of a drag of the first touch input, determining the screen zoom-in area based on a drag distance of the first touch input.

5. The method of claim 1, wherein determining the zoom-in area comprises:
in response to detecting a touch input for a zoom-in icon, activating a screen zoom-in mode; and
in response to detecting at least two touch inputs, determining the zoom-in area based on multiple touch points associated with the touch inputs.

6. The method of claim 1, wherein determining the zoom-in ratio comprises:
determining a size of the zoom-in area;
determining a total size of a display area; and
determining the zoom-in ratio based on the size of the zoom-in area and the total size of the display area.

7. The method of claim 1, wherein determining the zoom-in ratio comprises confirming a zoom-in ratio determined by a user.

8. An apparatus for zooming in a screen in an electronic device, the apparatus comprising:
a touch screen; and
a controller configured to, in response to detecting a touch input through the touch screen, generate a display of a zoom-in area, determined based on touch information, by zooming into the zoom-in area according to a zoom-in ratio.

9. The apparatus of claim 8, wherein in response to detecting a multi-touch input through the touch screen, the controller is configured to determine the zoom-in area based on multiple touch points associated with the multi-touch input.

10. The apparatus of claim 8, wherein in response to detecting a first touch input, the controller is configured to activate a screen zoom-in mode through the touch screen based on a touch duration time of the first touch input, and in response to detecting a second touch input, determine the zoom-in area based on multiple touch points associated with the first touch input and the second touch input.

11. The apparatus of claim 8, wherein in response to detecting a first touch input, the controller is configured to activate a screen zoom-in mode through the touch screen based on a touch duration time of the first touch input, and in response to detecting a drag of the first touch input, determines the screen zoom-in area based on a drag distance of the first touch input.

12. The apparatus of claim 8, wherein in response to detecting a touch input for a zoom-in icon through the screen touch, the controller is configured to activate a screen zoom-in mode, and in response to detecting at least two touch inputs through the touch screen, determine the zoom-in area based on multiple touch points associated with the touch inputs.

13. The apparatus of claim 8, wherein the controller is configured to determine the zoom-in ratio by comparing the size of the zoom-in area and the total size of the display area.

14. The apparatus of claim 8, wherein the controller is configured to determine a zoom-in ratio determined by a user.

15. A non-transitory computer-readable medium embodying a program, the program comprising program code for:
in response to detecting a touch input on a touch screen, determining a zoom-in area based on touch information
determining a zoom-in ratio for the zoom-in area; and
displaying the zoom-in area by zooming into the zoom-in area according to the zoom-in ratio.

16. The computer-readable medium of claim 15, further comprising program code for, in response to detecting a multi-touch input through the touch screen, determining the zoom-in area based on multiple touch points associated with the multi-touch input.

17. The computer-readable medium of claim 15, further comprising program code for, in response to detecting a first touch input through the touch screen, activating a screen zoom-in mode based on a touch duration time of the first touch input, and in response to detecting a second touch input, determining the zoom-in area based on multiple touch points associated with the first touch input and the second touch input.

18. The computer-readable medium of claim 15, further comprising a program code for, in response to detecting a first touch input through the touch screen, activating a screen zoom-in mode based on a touch duration time of the first touch input, and in response to detecting a drag of the first touch input, determining the screen zoom-in area based on a drag distance of the first touch input.

19. The computer-readable medium of claim 15, further comprising program code for, in response to detecting a touch input for a zoom-in icon through the touch screen, activating a screen zoom-in mode, and in response to detecting at least two touch inputs through the touch screen, determining the zoom-in area based on multiple touch points based on the touch inputs.

20. The computer-readable medium of claim 15, further comprising program code for determining the zoom-in ratio by comparing the size of the zoom-in area and the total size of the display area.

21. The computer-readable medium of claim 15, further comprising program code for confirming a zoom-in ratio determined by a user.
